(19) United States
(12) Patent Application Publication
(10) Pub. No.: US 2022/0292842 A1
(43) Pub. Date: Sep. 15, 2022

(54) COMPUTER-IMPLEMENTED METHOD AND SYSTEM FOR ASSIGNING A NUMERICAL VALUE TO AN ANNOTATION OF AN OBJECT

(71) Applicant: dSPACE GmbH, Paderborn (DE)

(72) Inventors: Daniel Roedler, Karlsruhe (DE); Stefan Rinke, Karlsruhe (DE)

(21) Appl. No.: 17/770,635

(22) PCT Filed: Oct. 12, 2020
(86) PCT No.: PCT/EP2020/078538

§ 371 Date: Apr. 21, 2022

(30) Foreign Application Priority Data
Oct. 24, 2019 (EP) 19204989.8

(51) Int. Cl. G06V 20/58; G06V 20/70

(52) U.S. Cl. CPC G06V 20/58; G06V 20/70

(57) ABSTRACT

A computer-implemented method includes: identifying and annotating at least one object in received image, video, and/or point cloud data, wherein the identifying and/or annotating is automatically performed at least in part; calculating the numerical value of the annotation of the at least one object, wherein the numerical value is calculated at least in part on the basis of a degree of the correlation of a dimension of a visual annotation in relation to a dimension of the at least one object and/or of a correlation of a conceptual identifier of the at least one object with the at least one object and/or of a conceptual identifier of at least one sensor detecting the at least one object with the at least one sensor; and assigning the calculated numerical value to the at least one object.

### CROSS-REFERENCE TO PRIOR APPLICATIONS

This application is a U.S. National Phase application under 35 U.S.C. § 371 of International Application No. PCT/EP2020/078538, filed on Oct. 12, 2020, and claims benefit to European Patent Application No. EP 19204989.8, filed on Oct. 24, 2019. The International Application was published in German on Apr. 29, 2021 as WO 2021/078550 A1 under PCT Article 21(2).

### FIELD

The present invention relates to a computer-implemented method for assigning a numerical value to an annotation of at least one object identified in image, video, and/or point cloud data.

The present invention further relates to a system for assigning a numerical value to an annotation of at least one object identified in image, video, and/or point cloud data.

The present invention additionally relates to a computer program.

### BACKGROUND

Computer vision models, i.e. algorithms for recognizing objects in image, video, and/or point cloud data, are trained with the aid of training data. To be able to reliably recognize objects in the image, video, and/or point cloud data, conventionally the objects in question are visually and/or conceptually annotated.

The aforementioned objects are conventionally classified manually by annotators using suitable software tools. In the field of computer vision models for autonomous driving, the images are generally annotated using so-called bounding boxes. By way of these, vehicles, road signs, and other objects in the surroundings, for example, can be marked or annotated.

The CVPR publication by the Computer Vision Foundation entitled “Interactive full image segmentation by considering all regions jointly” discloses a software application which, when extreme points of certain image objects are annotated, enables a prediction for a full image segmentation, i.e. a division of the full image into the objects included therein.

The software application additionally has the feature whereby, in the event of an erroneous prediction of certain regions of the image segmentation, the annotator can use a graphical user tool to make changes to the image segmentation, and these changes can then be implemented by the software application.

However, what the aforementioned methods have in common is that considerable annotation complexity is always involved since, to effectively train the computer vision models, a very high volume of training data and annotation thereof is required, which results in significant outlay in terms of manpower and money.

### SUMMARY

In an exemplary embodiment, the present invention provides a computer-implemented method for assigning a numerical value to an annotation of at least one object identified in image, video, and/or point cloud data. The method includes: identifying and annotating the at least one object in received image, video, and/or point cloud data, wherein the identifying and/or annotating is automatically performed at least in part; calculating the numerical value of the annotation of the at least one object, wherein the numerical value is calculated at least in part on the basis of a degree of the correlation of a dimension of a visual annotation in relation to a dimension of the at least one object and/or of a correlation of a conceptual identifier of the at least one object with the at least one object and/or of a conceptual identifier of at least one sensor detecting the at least one object with the at least one sensor; and assigning the calculated numerical value to the at least one object.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a flowchart of a method for assigning a numerical value to an annotation of at least one object identified in image, video, and/or point cloud data according to a preferred embodiment of the invention;

FIG. 2 is a schematic diagram of a performed annotation of objects in image, video, and/or point cloud data according to a preferred embodiment of the invention;

FIG. 3 is a schematic diagram of a performed annotation of objects in image, video, and/or point cloud data according to a preferred embodiment of the invention;

FIG. 4 is a block diagram of a plurality of object properties according to a preferred embodiment of the invention;

FIG. 5 is a block diagram of a plurality of sensor properties according to a preferred embodiment of the invention; and

FIG. 6 is a schematic diagram of a system for assigning a numerical value to an annotation of at least one object identified in image, video, and/or point cloud data according to a preferred embodiment of the invention.

Like reference signs designate like elements in the drawings unless otherwise indicated.

### DETAILED DESCRIPTION

Exemplary embodiments of the present invention provide for improvements with respect to annotating objects in image, video, and/or point cloud data to allow specified objects to be annotated in a simplified, more efficient, and less expensive manner.

Exemplary embodiments of the present invention provide a computer-implemented method, a system, and a computer program that allow specified objects in image, video, and/or point cloud data to be annotated in a simplified, more efficient, and less expensive manner.

Exemplary embodiments of the invention include a computer-implemented method for assigning a numerical value to an annotation of at least one object identified in image, video, and/or point cloud data, a system for assigning a numerical value to an annotation of at least one object identified in image, video, and/or point cloud data, and a computer program.

The invention relates to a computer-implemented method for assigning a numerical value to an annotation of at least one object identified in image, video, and/or point cloud data.

The method comprises identifying and annotating the at least one object in received image, video, and/or point cloud data, the identifying and/or annotating being automatically performed at least in part.

The method further comprises calculating the numerical value of the annotation of the at least one object, the numerical value being calculated at least in part on the basis of a degree of the correlation of a dimension of a visual annotation in relation to a dimension of the at least one object and/or of a correlation of a conceptual identifier of the at least one object with the at least one object and/or of a conceptual identifier of at least one sensor detecting the at least one object with the at least one sensor.

The method additionally comprises assigning the calculated numerical value to the at least one object.

The invention further relates to a system for assigning a numerical value to an annotation of at least one object identified in image, video, and/or point cloud data.

The system is configured for identifying and annotating the at least one object in received image, video, and/or point cloud data, the identifying and/or annotating being able to be automatically performed at least in part.

The system is further configured for calculating the numerical value of the annotation of the at least one object, the numerical value being able to be calculated at least in part on the basis of a degree of the correlation of a dimension of a visual annotation in relation to a dimension of the at least one object and/or of a correlation of a conceptual identifier of the at least one object with the at least one object and/or of a conceptual identifier of at least one sensor detecting the at least one object with the at least one sensor.

The system additionally is configured for assigning the calculated numerical value to the at least one object.

The invention further relates to a computer program comprising program code for carrying out the method according to the invention when the computer program is executed on a computer.

A concept of the present invention is firstly to allow objects to be automatically identified and annotated in image, video, and/or point cloud data at least in part. As a result, it is possible to save a considerable amount of time and processing work previously required for the activities performed manually, specifically in the field of computer vision models for autonomous traveling.

Another concept of the present invention is to calculate billing or pricing depending on whether predetermined technical parameters are reached, namely depending on an accuracy of a visual annotation and/or of a correct assignment of at least one conceptual annotation, by contrast with pay-per-use billing models that are usual in the field of cloud computing.

Further embodiments of the present invention are set out in the further dependent claims and the description below, with reference to the drawings.

According to one aspect of the invention, the method further includes that the conceptual identifier of the at least one object comprises at least one property of the object, and that the conceptual identifier of the at least one sensor detecting the at least one object comprises a property of the at least one sensor.

As a result, in addition to the visual annotation, a more accurate classification of the object in question can be made possible as part of the allocation of one or a plurality of properties of the object and/or labels of the sensor.

According to a further aspect of the invention, the method additionally includes that the visual annotating comprises automatically positioning and drawing a bounding element, which surrounds the object and is formed by a 2D bounding frame or, in particular in the case of LiDAR and/or radar image data, by a 3D bounding frame.

Owing to the automatic positioning and drawing of the corresponding bounding frame around the object in question, the objects included in the image, video, and/or point cloud data can be annotated precisely and efficiently, i.e. with less processing time.

According to a further aspect of the invention, the method further includes that the at least one property allocated to the object comprises at least one object category, a first object category comprising motor vehicles and a first object sub-category comprising passenger cars, trucks, delivery trucks, buses, construction vehicles, rail-borne vehicles, and/or trailer hitches, and a second object category comprising people and a second object sub-category comprising a gender, a height, and/or an age of the person.

In addition, it is likewise possible to classify other objects relevant for the computer vision model in question, for example road signs, buildings, etc. By classifying the objects into object categories and object sub-categories, the objects in question can be classified exactly and also a prediction of expected behavior of the object can be made.

According to a further aspect of the invention, the method further includes the step whereby the at least one property allocated to the sensor detecting the image, video, and/or point cloud data comprises at least one sensor category, a first sensor category comprising an image sensor and a first sensor sub-category comprising a position and orientation of the image sensor on a carrier device, in particular on a detection vehicle, and a second sensor category comprising a LiDAR sensor and a third sensor category comprising a radar sensor.

Because the position and orientation of the image sensor relative to the detected object are known, a more accurate classification of the object can advantageously also be made possible.

According to a further aspect of the invention, the method further includes that the first sensor sub-category comprises a wide-angle camera arranged centrally on the front on the carrier device, in particular on the detection vehicle, a narrow-angle camera arranged centrally on the front, a camera arranged on the front left, a camera arranged on the front right, a camera arranged on the back left, a camera arranged on the back right, and/or a wide-angle camera arranged centrally on the back.

A 360° detection of the surrounding traffic situation, including moving and stationary objects, is thus advantageously possible.

According to a further aspect of the invention, the method additionally includes that the at least one object in the image, video, and/or point cloud data is identified and visually annotated manually, in particular by a user, and the at least one property of the object and/or the at least one property of the at least one sensor that detects the at least one object being automatically allocated.

As a result, the method according to the invention can advantageously also be applied when the step of identifying and visually annotating the at least one object in the image, video, and/or point cloud data is performed manually by a user and, on that basis, properties are automatically allocated to the object and/or the sensor detecting the image, video, and/or point cloud data is automatically labeled.

According to a further aspect of the invention, the method further includes that the degree of the correlation of the dimension of the visual annotation in relation to the dimension of the at least one object and/or the correlation of the conceptual identifier of the at least one object with the at least one object and/or of the conceptual identifier of the at least one sensor detecting the at least one object with the at least one sensor is checked by a user.

The highest possible accuracy of the visual annotation and/or a correctness of the conceptual annotation can thus advantageously be made possible. Therefore, with high efficiency or efficacy of the computer-implemented method of the automatic visual and conceptual annotation, only a relatively low amount of additional work through post-processing by the user is thus involved.

According to a further aspect of the invention, the method additionally includes that the degree of the correlation of the dimension of the visual annotation in relation to the dimension of the at least one object is evaluated as being sufficient if the dimension of the bounding element corresponds substantially to the dimension, in particular the outer dimension, of the annotated object.

An objective evaluation criterion for determining the accuracy of the visual annotation can thus advantageously be provided.

According to a further aspect of the invention, the method additionally includes that, when performing the at least one visual annotation and/or the allocation of the at least one property of the object and/or of the at least one property of the sensor, a transaction dataset comprising a piece of information required for calculating the numerical value of the annotation, in particular at least one automatically performed action, is created and stored in a transaction data memory.

Each individual performed action is therefore advantageously stored in the transaction dataset, i.e. what is stored is whether the annotation is a visual and/or conceptual annotation and whether the conceptual annotation includes the allocating of object properties and/or sensor properties.

According to a further aspect of the invention, the method further includes that a change made by the user to the annotation of the object, in particular a change to the visual annotation and/or a change to the at least one property of the object and/or to the property of the at least one sensor detecting the image, video, and/or point cloud data, is incorporated into the transaction dataset of the object, or into a transaction dataset linked to the transaction dataset of the object, and stored in the transaction data memory.

Therefore, in addition to the annotation steps automatically performed by the computer-implemented method, the transaction dataset can also register whether and to what extent changes have been made to the annotation of the object in question. A transaction dataset of this kind then forms the basis for pricing the performed actions.

According to a further aspect of the invention, the method further includes that the numerical value of the annotation forms a price of the annotation, each entry included in the transaction dataset and related to a performed action being priced by an evaluation module using a pricing plan. Therefore, the performed actions can advantageously be priced exactly.

According to a further aspect of the invention, the method further includes that the evaluation module forms a first sum from the numerical value of the at least one entry of the at least one, in particular automatically performed, annotation, and if the transaction dataset comprises at least one entry of a change made by the user, the evaluation module forms a second sum from the numerical value of the at least one entry of the change made by the user, and the second sum being subtracted from the first sum in order to calculate the numerical value, in particular the price, of the annotation.

The method according to the invention thus advantageously prices the performed annotation of the object in question depending on the specified technical parameters, namely the accuracy of the visual annotation and the correct allocation of the conceptual annotation, and enables corresponding, success-based billing for the provided services.

The method features described herein are also applicable to scenarios other than computer vision models, for example person recognition in different environments.

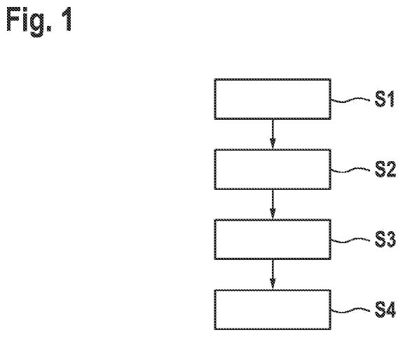

FIG. 1 is a flowchart of a method for assigning a numerical value to an annotation of at least one object identified in image, video, and/or point cloud data according to a preferred embodiment of the invention.

The method comprises identifying S1 and annotating S2 the at least one object 14a, 14b in received image, video, and/or point cloud data 12. In this case, the identifying S1 and/or annotating S2 is/are automatically performed at least in part.

Alternatively, it is possible to perform the identifying S1 and a visual annotating 10a, S2 of the at least one object 14a, 14b in the image, video, and/or point cloud data manually, i.e. by a user.

The method further comprises calculating S3 the numerical value of the annotation 10a, 10b of the at least one object 14a, 14b. In the process, the numerical value corresponds to the price to be billed for the annotation 10a, 10b.

The numerical value is calculated at least in part on the basis of a degree of the correlation of a dimension 34a, 34b of a visual annotation 10a in relation to a dimension 36a, 36b of the at least one object 14a, 14b and/or of a correlation of a conceptual identifier 10b of the at least one object 14a, 14b with the at least one object 14a, 14b and/or of a conceptual identifier 10c of at least one sensor 16a, 16b detecting the at least one object 14a, 14b with the at least one sensor 16a, 16b.

The degree of the correlation of the dimension 34a, 34b of the visual annotation 10a in relation to the dimension 36a, 36b of the at least one object means that the visual annotation, for example a bounding frame, in relation to the object is measured properly in terms of its dimension and position.

Relative to the object, therefore, the bounding frame is thus neither too small nor too large and is also correctly positioned and/or oriented in relation to the object.

The correlation of the conceptual identifier 10b of the at least one object 14a, 14b with the at least one object 14a, 14b means that the image content correlates with the conceptual content, i.e. a passenger car detected for example in the image, video, and/or point cloud data is also correctly labeled conceptually as such.

The correlation of the conceptual identifier 10c of the at least one sensor 16a, 16b detecting the at least one object 14a, 14b with the at least one sensor 16a, 16b means that the relevant sensor or sensors by which the image, video, and/or point cloud data have been obtained is/are properly labeled.

If the image, video, and/or point cloud data have, for example, been obtained using a wide-angle camera 32a arranged centrally on the front and a camera 32c arranged on the front left, these cameras should thus be properly conceptually labeled or correctly allocated to the image, video, and/or point cloud data.

In addition, the method comprises assigning S4 the calculated numerical value to the at least one object 14a, 14b.

Furthermore, the at least one object is automatically identified S1 and annotated S2, preferably using a machine learning algorithm, for example an artificial neural network.

The annotating S2 comprises the visual annotation 10a and the allocation of a predetermined number of properties 10b1 to the at least one object 14a, 14b and/or the labeling 10b2 of at least sensor 16a, 16b detecting the image, video, and/or point cloud data 12 in relation to the object 14a, 14b.

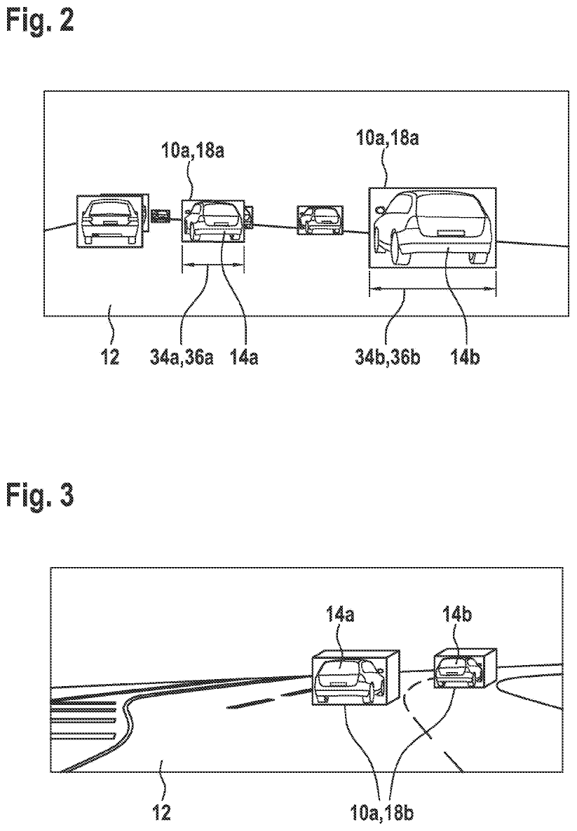

FIG. 2 is a schematic diagram of a performed annotation of objects in image, video, and/or point cloud data according to the preferred embodiment of the invention.

The visual annotating 10a comprises automatically positioning and drawing a bounding element 18a, which surrounds the object 14a, 14b. In this illustration, the bounding element 18a is formed by a 2D bounding frame 18a.

The accuracy of the visual annotation 10a is checked by a user.

In this case, the visual annotation 10a is deemed accurate if the visual annotation 10a meets user-defined, dimension-based requirements, in particular if a dimension 34a, 34b of the bounding element 18a, 18b corresponds substantially to an outer dimension 36a, 36b of the annotated object 14a, 14b.

The aim of the automatic positioning and drawing of the corresponding bounding frame 18a around the object 14a, 14b in question is to fully automate the process of annotating objects 14a, 14b in image, video, and/or point cloud data 12 and thus eliminate the need for post-processing by the user.

The objects included in the image, video, and/or point cloud data can thus be annotated precisely, efficiently, and with lower costs.

FIG. 3 is a schematic diagram of a performed annotation of objects in image, video, and/or point cloud data according to the preferred embodiment of the invention.

The visual annotating 10a comprises automatically positioning and drawing a bounding element 18b, which surrounds the object 14a, 14b.

In this example, the bounding element 18b is formed by a 3D bounding frame 18b. In this illustration, the data are image and/or video data 12. 3D bounding frames are additionally suitable in particular for LiDAR and/or radar image data, i.e. in point cloud data.

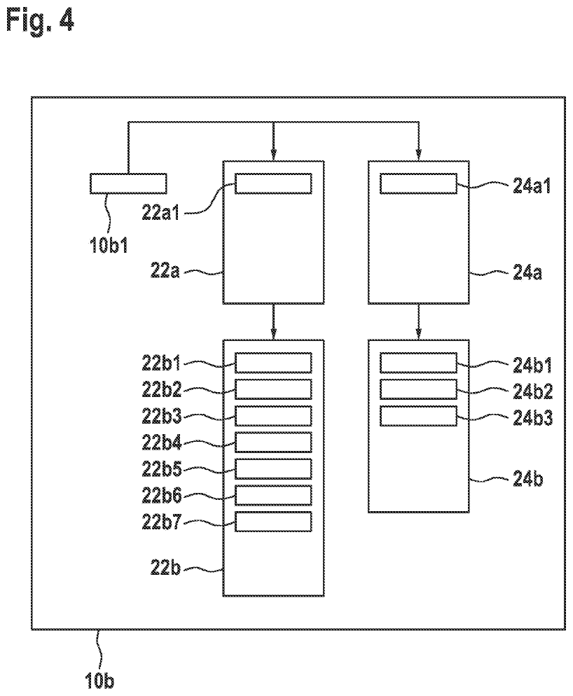

FIG. 4 is a block diagram of a plurality of object properties according to the preferred embodiment of the invention.

The predetermined number of properties 10b1 that is allocated to the object comprises at least one object category.

A first object category 22a comprises motor vehicles 22a1. A first object sub-category 22b comprises passenger cars 22b1, trucks 22b2, delivery trucks 22b3, buses 22b4, construction vehicles 22b5, rail-borne vehicles 22b6, and/or trailer hitches 22b7.

A second object category 24a comprises people 24a1. A second object sub-category 24b comprises a gender 24b1, a height 24b2, and/or an age 24b3 of the person 24a1. In the process, the correct allocation of the at least one property 10b1 to the object is checked by a user.

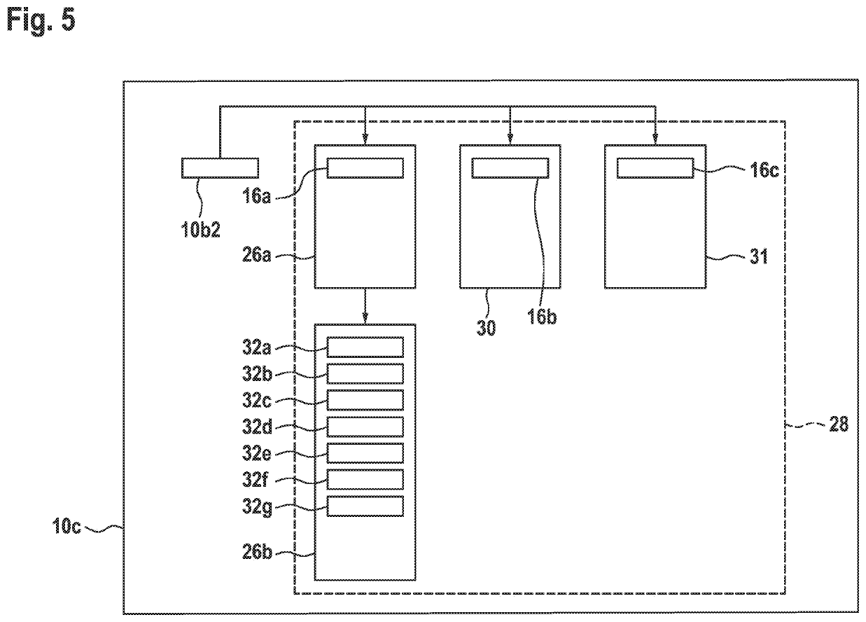

FIG. 5 is a block diagram of a plurality of sensor properties according to the preferred embodiment of the invention.

The conceptual identifier 10c relates to the at least one sensor 16a, 16b detecting the at least one object.

The predetermined number of properties 10b2 that is allocated to the sensor 16a, 16b detecting the image, video, and/or point cloud data 12 comprises at least one sensor category. A first sensor category 26a comprises an image sensor 16a.

A first sensor sub-category 26b comprises a position and orientation of the image sensor 16a on a detection vehicle 28. A second sensor category 30 comprises a LiDAR sensor and a third sensor category 31 comprises a radar sensor 16c.

Alternatively to the detection vehicle 28, the sensor 16a, 16b can, for example, be arranged on a stationary carrier device, for example on a building and/or a road sign.

In another alternative, the sensor 16a, 16b can, for example, be arranged on a rail-borne vehicle and/or an aircraft.

When the sensor 16a, 16b is arranged on a building, for example in a parking garage, motor vehicles that are parking, entering, and/or exiting can be detected by the sensor.

When the sensor 16a, 16b is arranged on a road sign, for example on traffic lights and/or an indicator board of a traffic control system, motor vehicles traveling past can be detected by the sensor.

The first sensor sub-category 26b comprises a wide-angle camera 32a arranged centrally on the front on the detection vehicle 28, a narrow-angle camera 32b arranged centrally on the front, a camera 32c arranged on the front left, a camera 32d arranged on the front right, a camera 32e arranged on the back left, a camera 32f arranged on the back right, and/or a wide-angle camera 32g arranged centrally on the back.

Alternatively, the computer-implemented method according to the invention can, for example, assign a numerical value to an annotation of at least one object identified in audio data, in particular speech data, and/or structured data.

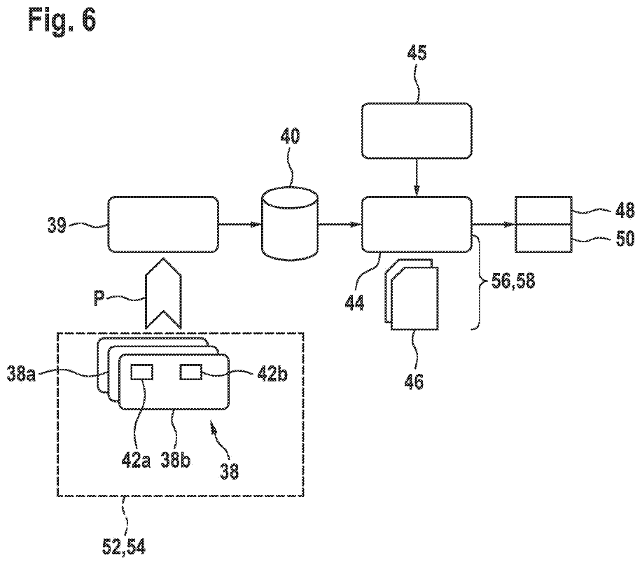

FIG. 6 is a schematic diagram of a system for assigning a numerical value to an annotation of at least one object identified in image, video, and/or point cloud data according to the preferred embodiment of the invention.

The system comprises components or devices 52, 54 for identifying and annotating the at least one object 14a, 14b in received image, video, and/or point cloud data 12, the identifying and/or annotating being able to be automatically performed at least in part.

The system further comprises a component or device 56 for calculating the numerical value of the annotation 10a, 10b of the at least one object 14a, 14b.

In the process, the numerical value can be calculated at least in part on the basis of a degree of the correlation of a dimension 34a, 34b of a visual annotation 10a in relation to a dimension 36a, 36b of the at least one object 14a, 14b and/or of a correlation of a conceptual identifier 10b of the at least one object 14a, 14b with the at least one object 14a, 14b and/or of a conceptual identifier 10c of at least one sensor 16a, 16b detecting the at least one object with the at least one sensor 16a, 16b.

The system additionally comprises a component or device 58 for assigning S4 the calculated numerical value to the at least one object 14a, 14b.

In the process, when performing the at least one visual annotation and/or the allocation of the at least one property of the object and/or of the label of the at least one sensor detecting the image, video, and/or point cloud data, a transaction dataset 38 comprising a piece of information required for calculating the price of the annotation, in particular at least one automatically performed action, is created and stored in a transaction data memory 40.

With each new annotation of an object, a corresponding transaction dataset 38 is created and sent to a transaction gateway 39 by a push message P, from which transaction gateway the transaction dataset 38a is forwarded to the transaction data memory 40 and stored therein.

In the process, a change 42a, 42b made by the user to the annotation of the object, in particular a change 42a to the visual annotation and/or a change 42b to the at least one property of the object and/or to a property of the at least one sensor detecting the image, video, and/or point cloud data, is incorporated into the transaction dataset 38 of the object, or alternatively into a transaction dataset 38 linked to the transaction dataset 38 of the object 14a, 14b, and stored in the transaction data memory 40.

Each entry 38a, 38b included in the transaction dataset 38 and related to a performed action is priced by an evaluation module 44 using a pricing plan 46. The evaluation module 44 forms a first sum 48 from the price of the at least one entry 38a of the at least one automatically performed annotation.

If the transaction dataset 38 comprises at least one entry 38b of a change 42a, 42b made by the user, the evaluation module 44 forms a second sum 50 from the price of the at least one entry 38b of the change 42a, 42b made by the user. The second sum 50 is then subtracted from the first sum 48 in order to calculate the price of the annotation.

Alternatively, the entry 38a and the entry 38b can be stored in two separate transaction datasets 38, the transaction datasets 38 being linked together such that it is possible to calculate the price of the annotation using the entries 38a, 38b in both transaction datasets 38.

In the event that there is no change to the transaction dataset, the first sum 48 is decisive for determining the price. A further determinant in the pricing of the performed actions is a subscription module 45, which contains conditions stored for the customer in question, for example a discount on the pricing plan 46.

Although specific embodiments have been illustrated and described herein, it will be appreciated by a person skilled in the art that a multiplicity of alternative and/or equivalent implementations exist. It should be noted that the exemplary embodiment or exemplary embodiments are only examples, and are not intended to limit the scope, applicability, or configuration in any way.

Rather, the foregoing summary and detailed description will provide those skilled in the art with a convenient road map for implementing at least one exemplary embodiment; it goes without saying that various changes may be made in the functional scope and arrangement of elements without departing from the scope of the appended claims and their legal equivalents.

Generally speaking, this application is intended to cover amendments, adaptations, or variations to the embodiments set out herein.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented method for assigning a numerical value to an annotation of at least one object identified in image, video, and/or point cloud data, comprising the steps of:
identifying and annotating the at least one object in received image, video, and/or point cloud data, wherein the identifying and/or annotating is automatically performed at least in part;
calculating the numerical value of the annotation of the at least one object, wherein the numerical value is calculated at least in part on the basis of a degree of the correlation of a dimension of a visual annotation in relation to a dimension of the at least one object and/or of a correlation of a conceptual identifier of the at least one object with the at least one object and/or of a conceptual identifier of at least one sensor detecting the at least one object with the at least one sensor; and
assigning the calculated numerical value to the at least one object.

2. The computer-implemented method according to claim 1, wherein the conceptual identifier of the at least one object comprises at least one property of the at least one object, and the conceptual identifier of the at least one sensor detecting the at least one object comprises a property of the at least one sensor.

3. The computer-implemented method according to claim 1, wherein the visual annotation is based on automatically positioning and drawing a bounding element, which surrounds the at least one object and is formed by a 2D bounding frame or a 3D bounding frame.

4. The computer-implemented method according to claim 2, wherein the at least one property allocated to the at least one object comprises:
a first object category comprising motor vehicles;
a first object sub-category comprising passenger cars, trucks, delivery trucks, buses, construction vehicles, rail-borne vehicles, and/or trailer hitches, and
a second object category comprising people; and
a second object sub-category comprising a gender, a height, and/or an age of the a person.

5. The computer-implemented method according to claim 2, wherein the at least one property allocated to the at least one sensor detecting the image, video, and/or point cloud data comprises:
a first sensor category comprising an image sensor;
a first sensor sub-category comprising a position and orientation of the image sensor on a carrier device, in particular on a detection vehicle, and
a second sensor category comprising a LiDAR sensor and
a third sensor category comprising a radar sensor.

6. The computer-implemented method according to claim 5, wherein the first sensor sub-category comprises a wide-angle camera arranged centrally on the front on the detection vehicle, a narrow-angle camera arranged centrally on the front, a camera arranged on the front left, a camera arranged on the front right, a camera arranged on the back left, a camera arranged on the back right, and/or a wide-angle camera arranged centrally on the back.

7. The computer-implemented method according to claim 2, wherein the at least one object in the image, video, and/or point cloud data is identified and visually annotated manually, by a user, and the at least one property of the at least one object and/or the at least one property of the at least one sensor that detects the at least one object are automatically allocated.

8. The computer-implemented method according to claim 1, wherein the degree of the correlation of the dimension of the visual annotation in relation to the dimension of the at least one object and/or the correlation of the conceptual identifier of the at least one object with the at least one object and/or of the conceptual identifier of the at least one sensor detecting the at least one object with the at least one sensor is checked by a user.

9. The computer-implemented method according to claim 8, wherein the degree of the correlation of the dimension of the visual annotation in relation to the dimension of the at least one object is evaluated as being sufficient based on the dimension of the bounding element corresponding substantially to the outer dimension of the annotated object.

10. The computer-implemented method according to claim 2, wherein, when performing the at least one visual annotation and/or the allocation of the at least one property of the at least one object and/or of the at least one property of the at least one sensor, a transaction dataset comprising a piece of information required for calculating the numerical value of the annotation, in is created and stored in a transaction data memory.

11. The computer-implemented method according to claim 8, wherein a change made by the user to the annotation of the at least one object, in particular a change to the visual annotation and/or a change to the at least one property of the at least one object and/or to the property of the at least one sensor detecting the image, video, and/or point cloud data, is incorporated into the transaction dataset of the at least one object, or into a transaction dataset linked to the transaction dataset of the at least one object, and stored in the transaction data memory.

12. The computer-implemented method according to claim 10, wherein the numerical value of the annotation forms a price of the annotation, each entry included in the transaction dataset and related to a performed action being priced by an evaluation module using a pricing plan.

13. The computer-implemented method according to claim 12, wherein the evaluation module forms a first sum from the numerical value of the at least one entry of the at least one automatically performed annotation, and abased on the transaction dataset comprising at least one entry of a change made by the user, the evaluation module forms a second sum from the numerical value of the at least one entry of the change made by the user, and the second sum is subtracted from the first sum in order to calculate the numerical value, in particular the price, of the annotation.

14. A system for assigning a numerical value to an annotation of at least one object identified in image, video, and/or point cloud data, the system comprising:
at least one processor; and
at least one memory having processor-executable instructions stored thereon;
wherein the at least one processor is configured to execute the processor-executable instructions to facilitate the following being performed by the system:
identifying and annotating the at least one object in received image, video, and/or point cloud data, wherein the identifying and/or annotating is automatically performed at least in part;
calculating the numerical value of the annotation of the at least one object, wherein the numerical value is calculated at least in part on the basis of a degree of the correlation of a dimension of a visual annotation in relation to a dimension of the at least one object and/or of a correlation of a conceptual identifier of the at least one object with the at least one object and/or of a conceptual identifier of at least one sensor detecting the at least one object with the at least one sensor; and
assigning the calculated numerical value to the at least one object.

15. At least one non-transitory computer-readable medium having processor-executable instructions stored thereon for assigning a numerical value to an annotation of at least one object identified in image, video, and/or point cloud data, wherein the processor-executable instructions, when executed, facilitate:
identifying and annotating the at least one object in received image, video, and/or point cloud data, wherein the identifying and/or annotating is automatically performed at least in part;
calculating the numerical value of the annotation of the at least one object, wherein the numerical value is calculated at least in part on the basis of a degree of the correlation of a dimension of a visual annotation in relation to a dimension of the at least one object and/or of a correlation of a conceptual identifier of the at least one object with the at least one object and/or of a conceptual identifier of at least one sensor detecting the at least one object with the at least one sensor; and
assigning the calculated numerical value to the at least one object.
